(19) United States
(12) Patent Application Publication
(10) Pub. No.: US 2014/0166770 A1
(43) Pub. Date: Jun. 19, 2014

(54) DEVICES AND METHODS RELATED TO PAINT MIST COLLECTION DURING MANUFACTURE OF RADIO-FREQUENCY MODULES

(71) Applicant: SKYWORKS SOLUTIONS, INC., Woburn, MA (US)

(72) Inventor: Matthew Sean READ, Rancho Santa Margarita, CA (US)

(21) Appl. No.: 14/020,798

(22) Filed: Sep. 7, 2013

Related U.S. Application Data
(60) Provisional application No. 61/698,632, filed on Sep. 8, 2012.

(51) Int. Cl. B05B 15/04

(52) U.S. Cl. CPC B05B 15/0412
USPC 239/1; 239/120; 454/53

(57) ABSTRACT

Disclosed are systems, devices and methods related to paint mist collection during manufacture of packaged radio-frequency (RF) modules. In some embodiments, a mist-collection system can be implemented, where the system includes a platform configured to support a panel having an array of RF modules formed thereon. The system can further include a mist-collector positioned relative to the platform, with the mist-collector having an input in communication with an output. The mist-collector can be configured to provide suction at a region along one or more sides of the platform to thereby capture at least some of a paint mist generated during the paint-spraying process through the input. The system can further include a pump in communication with the mist-collector to provide the suction.

### CROSS-REFERENCE TO RELATED APPLICATIONS

This application claims priority to U.S. Provisional Application No. 61/698,632 filed Sep. 8, 2012 and entitled “SYSTEMS AND METHODS RELATED TO PAINT MIST COLLECTION,” which is expressly incorporated by reference herein in its entirety.

### BACKGROUND

1. Field

The present disclosure generally relates to devices and methods for collecting paint mist generated during manufacture of radio-frequency modules.

2. Description of the Related Art

In some processes involving manufacture of packaged radio-frequency (RF) modules, paint such as metallic paint can be applied. For example, metallic paint can be sprayed on a surface of a panel having an array of RF modules, to form a conductive RF-shielding layer. Such spray painting can yield paint mist which can accumulate at locations other than the intended location on the surface of the panel.

### SUMMARY

According to a number of implementations, the present disclosure relates to a device for spray-painting a panel having electronic modules formed thereon. The device includes a platform configured to support the panel during a paint-spraying process. The device further includes a mist-collector positioned relative to the platform. The mist-collector includes an input in communication with an output. The mist-collector is configured to be capable of providing suction at a region along one or more sides of the platform to thereby capture at least some of a paint mist generated during the paint-spraying process through the input.

In some embodiments, the platform can have a rectangular shape, and the mist collector can include a shaped conduit adjacent each of the four sides of the platform. The shaped conduit adjacent the longer side of the platform can have a horn shape with a wider end defining the input and a narrower end defining the output. The output can include an opening defined on a bottom surface of the horn shape. The wider end of the input can define a rectangle, and the panel can be positioned at a height that is between the upper and lower sides of the rectangular input. The rectangular input can have a length that is greater than the length of the panel such that the panel is between the lateral ends of the rectangular input.

In some embodiments, the shaped conduit adjacent the shorter side of the platform can have a box shape with one end defining the input and the opposite end defining the output. The output can include an opening defined on a side surface of the opposite end. The input end can define a rectangle, and the panel can be positioned at a height that is higher than the lower side of the rectangular input.

In some embodiments, the platform can be configured to secure the panel during the paint-spraying process. The platform can include a plurality of suction apertures configured to provide suction for holding the panel.

In some implementations, the present disclosure relates to a mist-collection system for spray-painting a panel having electronic modules formed thereon. The mist-collection system includes a platform configured to support the panel during a paint-spraying process. The mist-collection system further includes a mist-collector positioned relative to the platform. The mist-collector includes an input in communication with an output, and the mist-collector is configured to provide suction at a region along one or more sides of the platform to thereby capture at least some of a paint mist generated during the paint-spraying process through the input. The mist-collection system further includes a pump in communication with the mist-collector to provide the suction.

In some embodiments, the mist-collection system can further include a ducting assembly configured to connect the output of the mist-collector to the pump. The platform can have a rectangular shape, and the mist collector can include a shaped conduit adjacent each of the four sides of the platform. The ducting assembly can include a tubing having a first inner diameter for each of the four shaped conduits. The ducting assembly can further include a common ducting having a second inner diameter that is larger than the first diameter, with the common ducting being configured to couple the four tubings with the pump. The common ducting can include a reducing manifold having inputs dimensioned to couple to the four tubings and an output having the second diameter.

In some embodiments, the mist-collection system can be configured to provide at least 50 cubic feet per minute through each of the four shaped conduits. In some embodiments, the pump can include a regenerative blower.

According to a number of implementations, the present disclosure relates to a method for spray-painting a panel having electronic modules formed thereon. The method includes positioning the panel on a platform, spraying an electrically conductive paint on an upper surface of the panel, and providing suction to a region along one or more sides of the platform to thereby capture at least some of a paint mist generated during the spraying.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows a process that can be implemented to fabricate a packaged module that includes a die having an integrated circuit (IC).

FIGS. 2A1 and 2A2 show front and back sides of an example laminate panel configured to receive a plurality of dies for formation of packaged modules.

FIGS. 2B1 to 2B3 show various views of a laminate substrate of the panel configured to yield an individual module.

FIG. 2C shows an example of a fabricated semiconductor wafer having a plurality of dies that can be singulated for mounting on the laminate substrate.

FIG. 2D depicts an individual die showing example electrical contact pads for facilitating connectivity when mounted on the laminate substrate.

FIGS. 2E1 and 2E2 show various views of the laminate substrate being prepared for mounting of example surface-mount technology (SMT) devices.

FIGS. 2F1 and 2F2 show various views of the example SMT devices mounted on the laminate substrate.

FIGS. 2G1 and 2G2 show various views of the laminate substrate being prepared for mounting of an example die.

FIGS. 2H1 and 2H2 show various views of the example die mounted on the laminate substrate.

FIGS. 2I1 and 2I2 show various views of the die electrically connected to the laminate substrate by example wirebonds.

FIGS. 2J1 and 2J2 show various views of wirebonds formed on the laminate substrate and configured to facilitate electromagnetic (EM) isolation between an area defined by the wirebonds and areas outside of the wirebonds.

FIG. 2K shows a side view of molding configuration for introducing molding compound to a region above the laminate substrate.

FIG. 2L shows a side view of an overmold formed via the molding configuration of FIG. 2K.

FIG. 2M shows the front side of a panel with the overmold.

FIG. 2N shows a side view of how an upper portion of the overmold can be removed to expose upper portions of the EM isolation wirebonds.

FIG. 2O shows a portion of a panel where a portion of the overmold has its upper portion removed to better expose the upper portions of the EM isolation wirebonds.

FIG. 2P shows a side view of a conductive layer formed over the overmold such that the conductive layer is in electrical contact with the exposed upper portions of the EM isolation wirebonds.

FIG. 2Q shows a panel where the conductive layer can be a spray-on metallic paint.

FIG. 2R shows individual packaged modules being cut from the panel.

FIGS. 2S1 to 2S3 show various views of an individual packaged module.

FIG. 2T shows that one or more of modules that are mounted on a circuit board such as a wireless phone board can include one or more features as described herein.

FIG. 3A shows a process that can be implemented to install a packaged module having one or more features as described herein on the circuit board of FIG. 2T.

FIG. 3B schematically depicts the circuit board with the packaged module installed thereon.

FIG. 3C schematically depicts a wireless device having the circuit board with the packaged module installed thereon.

FIGS. 4A and 4B show plan and side views of an example painting platen having a plurality of mist-collecting features.

FIG. 5 schematically shows a mist-collection system having the painting platen of FIG. 4.

FIGS. 6A-6E show various examples associated with the mist-collection system of FIG. 5.

### DETAILED DESCRIPTION OF SOME EMBODIMENTS

The headings provided herein, if any, are for convenience only and do not necessarily affect the scope or meaning of the claimed invention.

Described herein are various examples of systems, apparatus, devices structures, materials and/or methods related to fabrication of packaged modules having a radio-frequency (RF) circuit and wirebond-based electromagnetic (EM) isolation structures. Although described in the context of RF circuits, one or more features described herein can also be utilized in packaging applications involving non-RF components. Similarly, one or more features described herein can also be utilized in packaging applications without the EM isolation functionality.

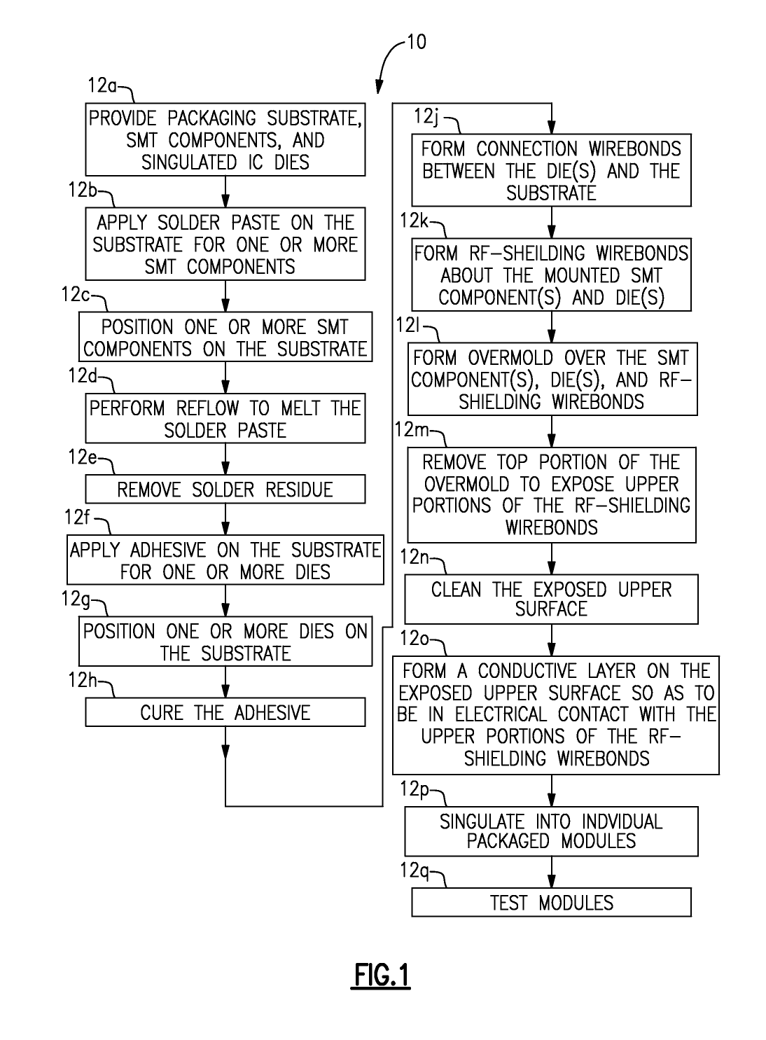

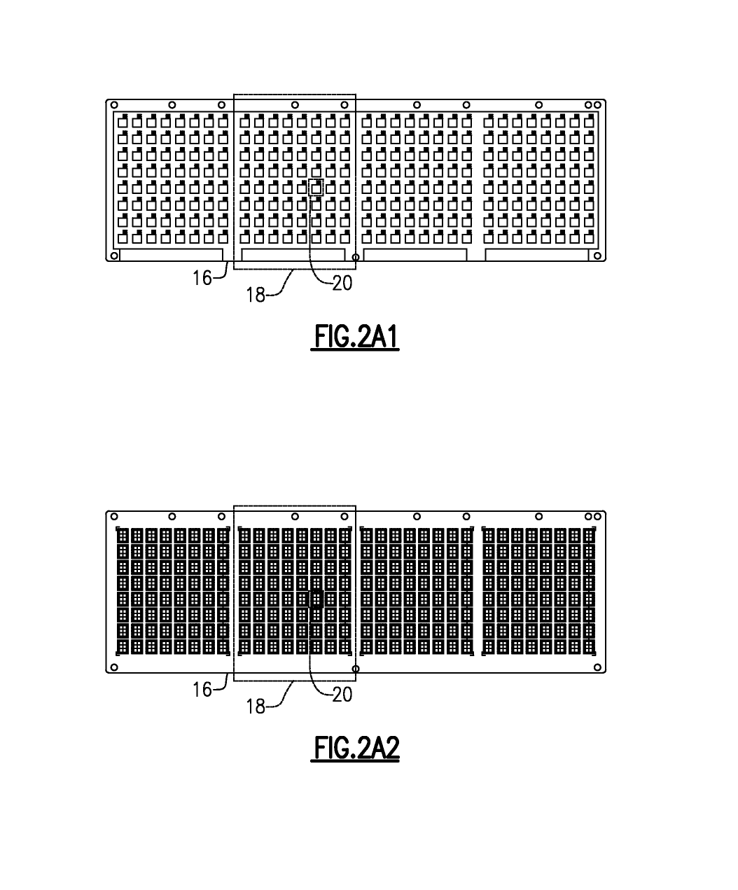

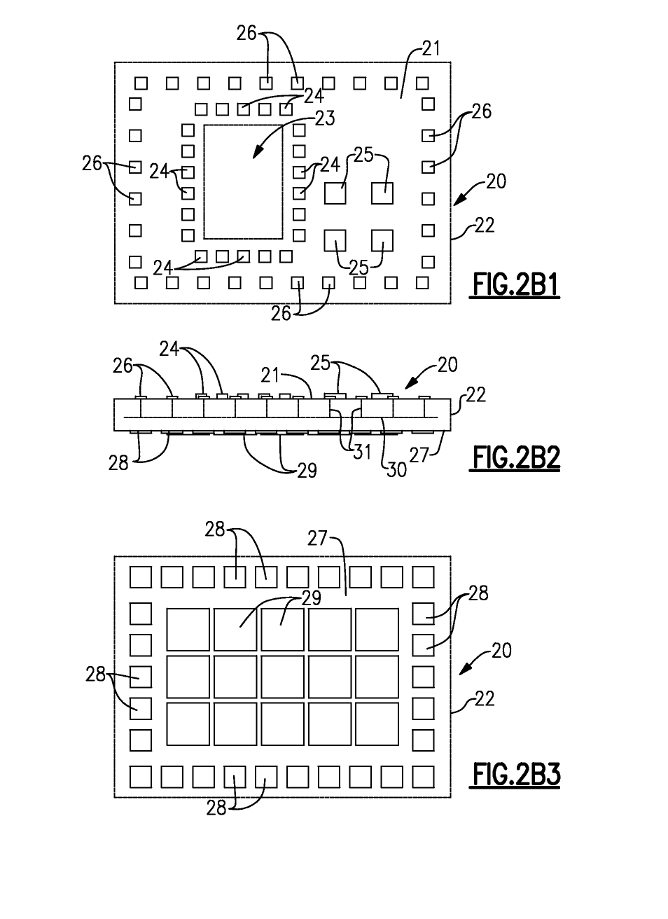

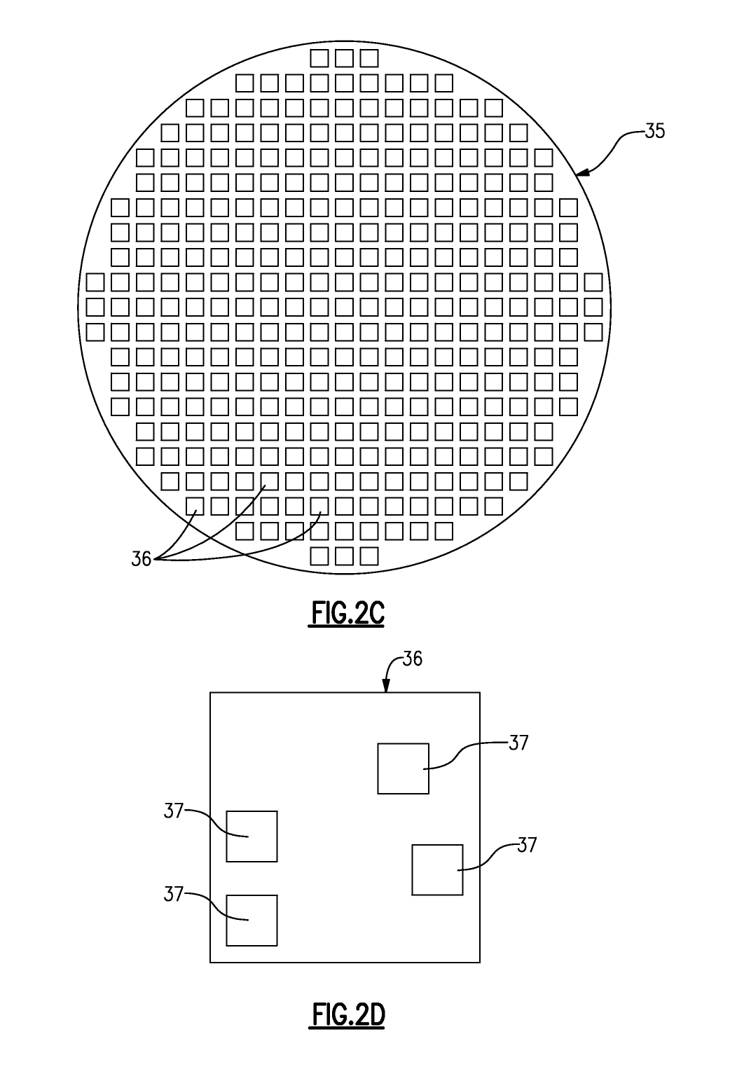

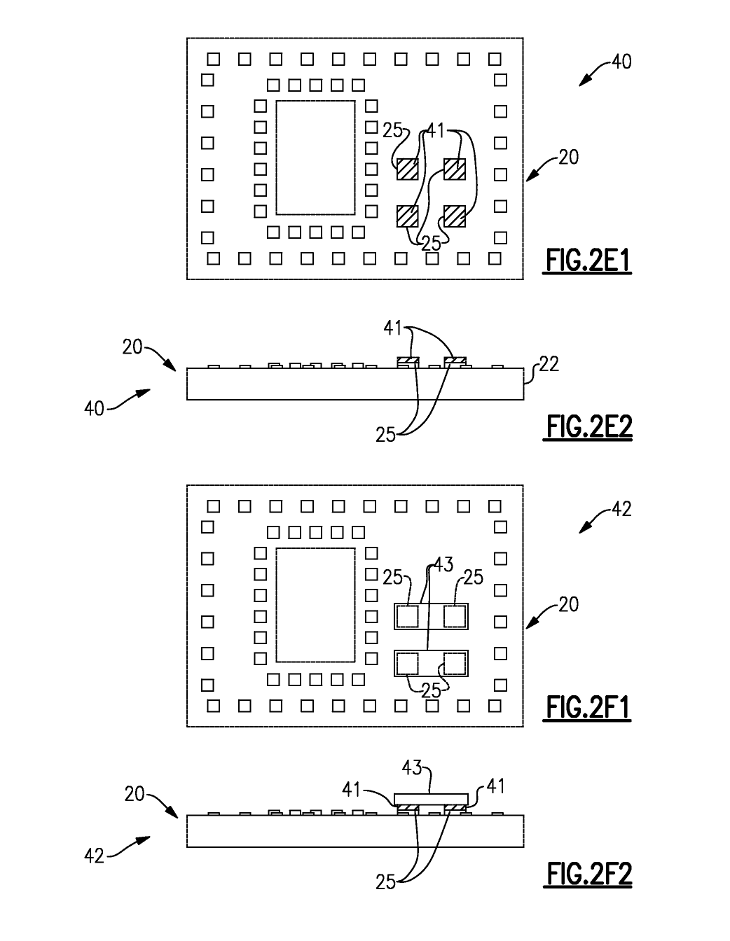

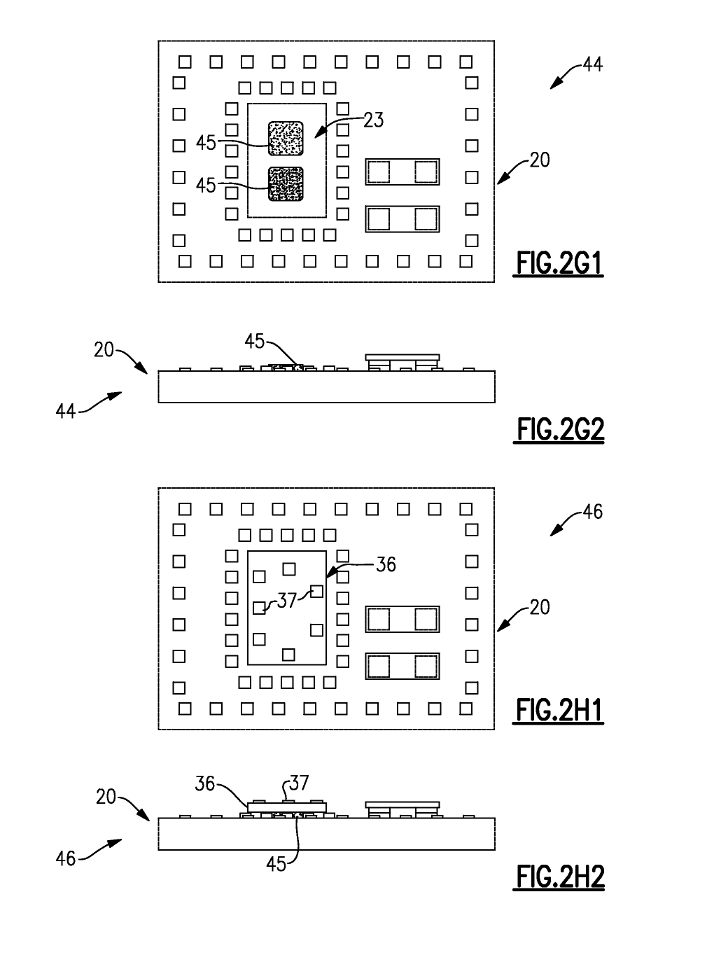

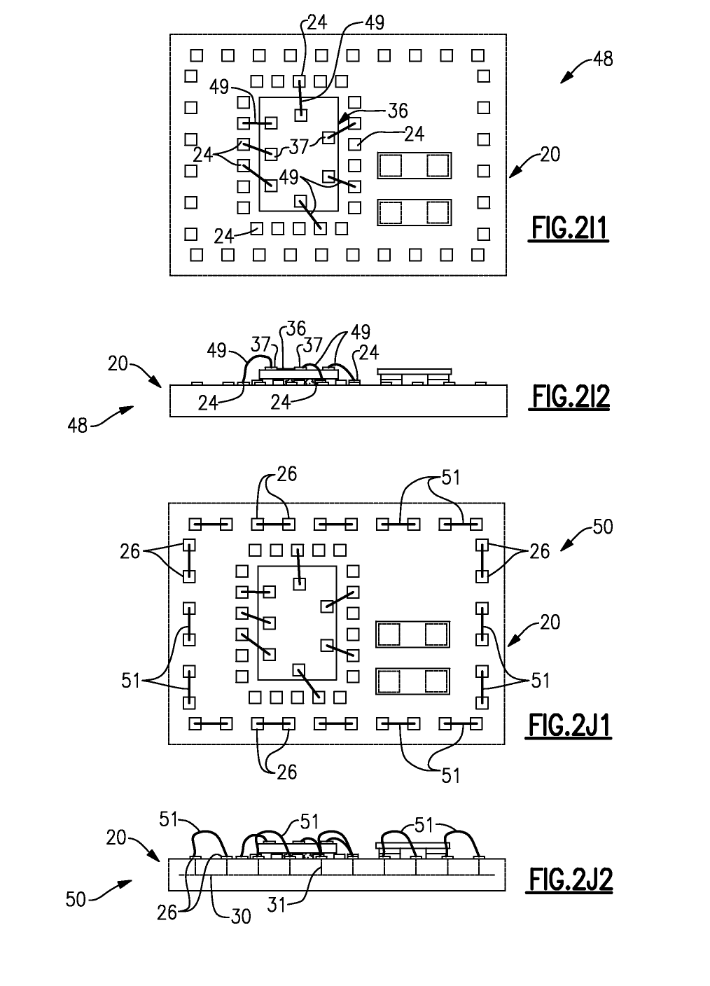

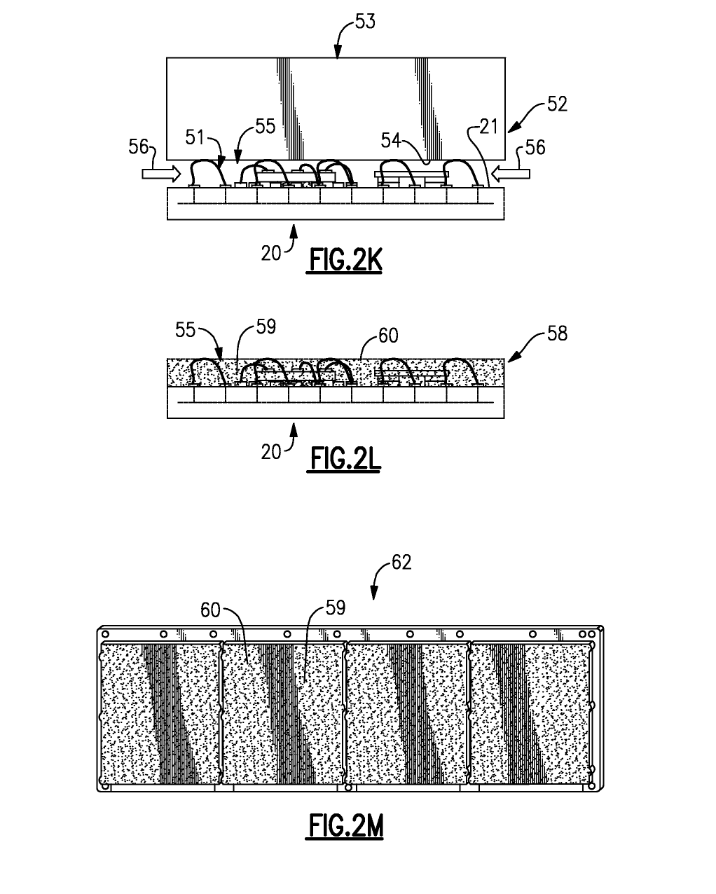

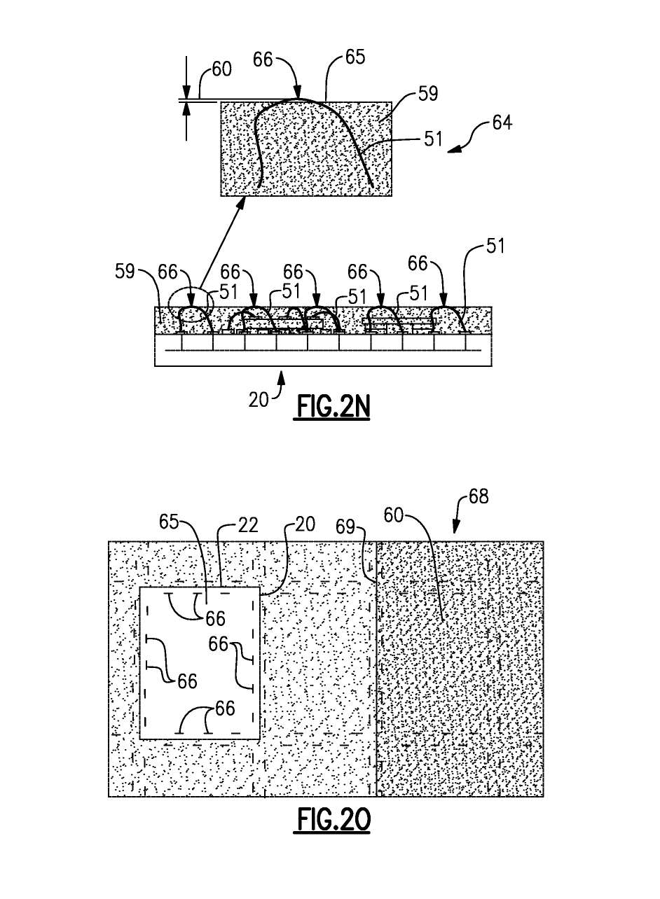

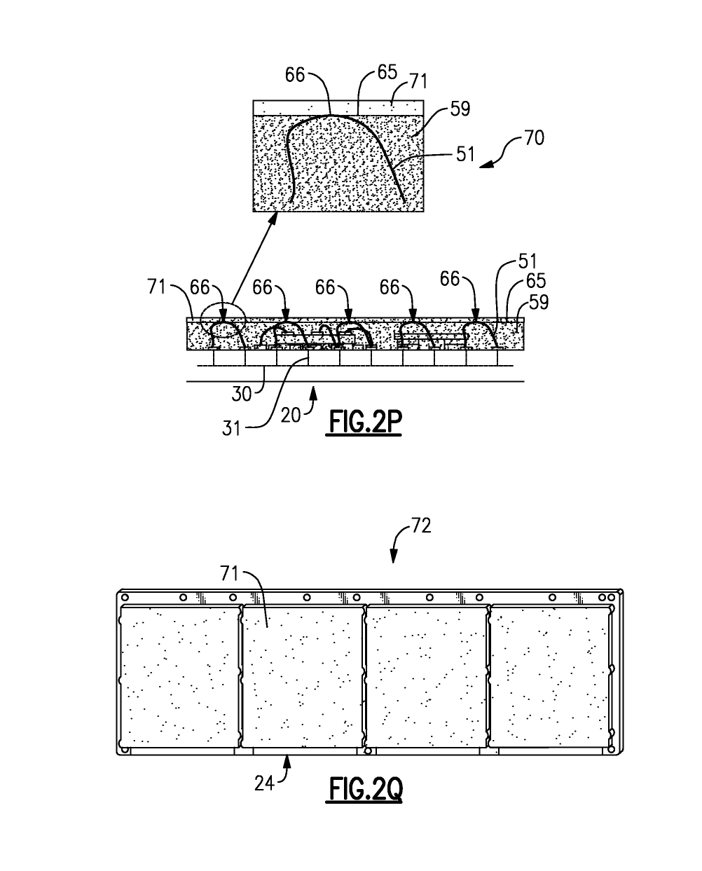

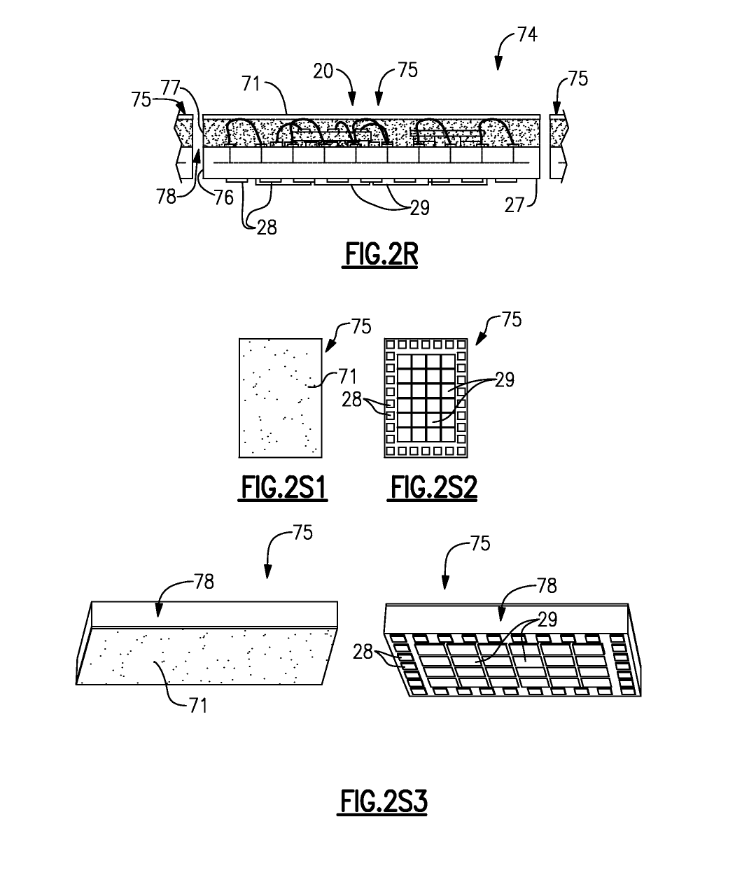

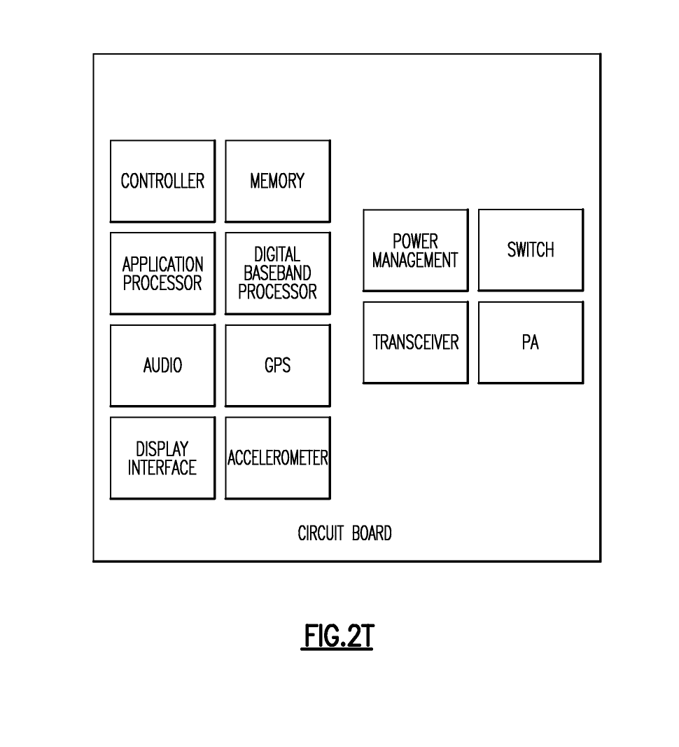

FIG. 1 shows a process 10 that can be implemented to fabricate a packaged module having and/or via one or more features as described herein. FIG. 2 shows various parts and/or stages of various steps associated with the process 10 of FIG. 1.

In block 12a of FIG. 1, a packaging substrate and parts to be mounted on the packaging substrate can be provided. Such parts can include, for example, one or more surface-mount technology (SMT) components and one or more singulated dies having integrated circuits (ICs). FIGS. 2A1 and 2A2 show that in some embodiments, the packaging substrate can include a laminate panel 16. FIG. 2A1 shows the example panel's front side; and FIG. 2A2 shows the panel's back side. The panel 16 can include a plurality of individual module substrates 20 arranged in groups that are sometimes referred to as cookies 18.

FIGS. 2B1-2B3 show front, side and back, respectively, of an example configuration of the individual module substrate 20. For the purpose of description herein, a boundary 22 can define an area occupied by the module substrate 20 on the panel 16. Within the boundary 22, the module substrate 20 can include a front surface 21 and a back surface 27. Shown on the front surface 21 is an example mounting area 23 dimensioned to receive a die (not shown). A plurality of example contact pads 24 (e.g., connection wirebond contact pads) are arranged about the die-receiving area 23 so as to allow formation of electrical connections between the die and contact pads 28 arranged on the back surface 27. Although not shown, electrical connections between the wirebond contact pads 24 and the module's contact pads 28 can be configured in a number of ways. Also within the boundary 22 are two sets of example contact pads 25 configured to allow mounting of, for example passive SMT devices (not shown). The contact pads 25 can be electrically connected to some of the module's contact pads 28 and/or ground contact pads 29 disposed on the back surface 27. Also within the boundary 22 are a plurality of wirebond pads 26 configured to allow formation of a plurality of EM-isolating wirebonds (not shown). The wirebond pads 26 can be electrically connected to an electrical reference plane (such as a ground plane) 30. Such connections between the wirebond pads 26 and the ground plane 30 (depicted as dotted lines 31) can be achieved in a number of ways. In some embodiments, the ground plane 30 may or may not be connected to the ground contact pads 29 disposed on the back surface 27.

FIG. 2C shows an example fabricated wafer 35 that includes a plurality of functional dies 36 awaiting to be cut (or sometimes referred to as singulated) into individual dies. Such cutting of the dies 36 can be achieved in a number of ways. FIG. 2D schematically depicts an individual die 36 where a plurality of metalized contact pads 37 can be provided. Such contact pads can be configured to allow formation of connection wirebonds between the die 36 and the contact pads 24 of the module substrate (e.g., FIG. 2B1).

In block 12b of FIG. 1, solder paste can be applied on the module substrate to allow mounting of one or more SMT devices. FIGS. 2E1 and 2E2 show an example configuration 40 where solder paste 41 is provided on each of the contact pads 25 on the front surface of the module substrate 20. In some implementations, the solder paste 41 can be applied to desired locations on the panel (e.g., 16 in FIG. 2A1) in desired amount by an SMT stencil printer.

In block 12c of FIG. 1, one or more SMT devices can be positioned on the solder contacts having solder paste. FIGS. 2F1 and 2F2 show an example configuration 42 where example SMT devices 43 are positioned on the solder paste 41 provided on each of the contact pads 25. In some implementations, the SMT devices 43 can be positioned on desired locations on the panel by an automated machine that is fed with SMT devices from tape reels.

In block 12d of FIG. 1, a reflow operation can be performed to melt the solder paste to solder the one or more SMT devices on their respective contact pads. In some implementations, the solder paste 41 can be selected and the reflow operation can be performed to melt the solder paste 41 at a first temperature to thereby allow formation of desired solder contacts between the contact pads 25 and the SMT devices 43.

In block 12e of FIG. 1, solder residue from the reflow operation of block 12d can be removed. By way of an example, the substrates can be run through a solvent or aqueous cleaning step. Such a cleaning step can be achieved by, for example, a nozzle spray, vapor chamber, or full immersion in liquid.

In block 12f of FIG. 1, adhesive can be applied on one or more selected areas on the module substrate 20 to allow mounting of one or more dies. FIGS. 2G1 and 2G2 show an example configuration 44 where adhesive 45 is applied in the die-mounting area 23. In some implementations, the adhesive 45 can be applied to desired locations on the panel (e.g., 16 in FIG. 2A1) in desired amount by techniques such as screen printing.

In block 12g of FIG. 1, one or more dies can be positioned on the selected areas with adhesive applied thereon. FIGS. 2H1 and 2H2 show an example configuration 46 where an example die 36 is positioned on the die-mounting area 23 via the adhesive 45. In some implementations, the die 36 can be positioned on the die-mounting area on the panel by an automated machine that is fed with dies from a tape reel.

In block 12h of FIG. 1, the adhesive between the die the die-mounting area can be cured. Preferably, such a curing operation can be performed at one or more temperatures that are lower than the above-described reflow operation for mounting of the one or more SMT devices on their respective contact pads. Such a configuration allows the solder connections of the SMT devices to remain intact during the curing operation.

In block 12j of FIG. 1, electrical connections such as wirebonds can be formed between the mounted die(s) and corresponding contact pads on the module substrate 20. FIGS. 2I1 and 2I2 show an example configuration 48 where a number of wirebonds 49 are formed between the contact pads 37 of the die 36 and the contact pads 24 of the module substrate 20. Such wirebonds can provide electrical connections for signals and/or power to and from one or more circuits of the die 36. In some implementations, the formation of the foregoing wirebonds can be achieved by an automated wirebonding machine.

In block 12k of FIG. 1, a plurality of RF-shielding wirebonds can be formed about a selected area on the module substrate 20. FIGS. 2J1 and 2J2 show an example configuration 50 where a plurality of RF-shielding wirebonds 51 are formed on wirebond pads 26. The wirebond pads 26 are schematically depicted as being electrically connected (dotted lines 31) with one or more reference planes such as a ground plane 30. In some embodiments, such a ground plane can be disposed within the module substrate 20. The foregoing electrical connections between the RF-shielding wirebonds 51 and the ground plane 30 can yield an interconnected RF-shielding structure at sides and underside of the area defined by the RF-shielding wirebonds 51. As described herein, a conductive layer can be formed above such an area and connected to upper portions of the RF-shielding wirebonds 51 to thereby form an RF-shielded volume.

In the example configuration 50, the RF-shielding wirebonds 51 are shown to form a perimeter around the area where the die (36) and the SMT devices (43) are located. Other perimeter configurations are also possible. For example, a perimeter can be formed with RF-wirebonds around the die, around one or more of the SMT devices, or any combination thereof. In some implementations, an RF-wirebond-based perimeter can be formed around any circuit, device, component or area where RF-isolation is desired. For the purpose of description, it will be understood that RF-isolation can include keeping RF signals or noise from entering or leaving a given shielded area.

In the example configuration 50, the RF-shielding wirebonds 51 are shown to have an asymmetrical side profile configured to facilitate controlled deformation during a molding process as described herein. Additional details concerning such wirebonds can be found in, for example, PCT Publication No. WO 2010/014103 titled “SEMICONDUCTOR PACKAGE WITH INTEGRATED INTERFERENCE SHIELDING AND METHOD OF MANUFACTURE THEREOF.” In some embodiments, other shaped RF-shielding wirebonds can also be utilized. For example, generally symmetric arch-shaped wirebonds as described in U.S. Pat. No. 8,071,431, titled “OVERMOLDED SEMICONDUCTOR PACKAGE WITH A WIREBOND CAGE FOR EMI SHIELDING,” can be used as RF-shielding wirebonds in place of or in combination with the shown asymmetric wirebonds. In some embodiments, RF-shielding wirebonds do not necessarily need to form a loop shape and have both ends on the surface of the module substrate. For example, wire extensions with one end on the surface of the module substrate and the other end positioned above the surface (for connecting to an upper conductive layer) can also be utilized.

In the example configuration 50 of FIGS. 2J1 and 2J2, the RF-shielding wirebonds 51 are shown to have similar heights that are generally higher than heights of the die-connecting wirebonds (49). Such a configuration allows the die-connecting wirebonds (49) to be encapsulated by molding compound as described herein, and be isolated from an upper conductive layer to be formed after the molding process.

In block 12I of FIG. 1, an overmold can be formed over the SMT component(s), die(s), and RF-shielding wirebonds. FIG. 2K shows an example configuration 52 that can facilitate formation of such an overmold. A mold cap 53 is shown to be positioned above the module substrate 20 so that the lower surface 54 of the mold cap 53 and the upper surface 21 of the module substrate 20 define a volume 55 where molding compound can be introduced.

In some implementations, the mold cap 53 can be positioned so that its lower surface 54 engages and pushes down on the upper portions of the RF-shielding wirebonds 51. Such a configuration allows whatever height variations in the RF-shielding wirebonds 51 to be removed so that the upper portions touching the lower surface 54 of the mold cap 53 are at substantially the same height. When the mold compound is introduced and an overmold structure is formed, the foregoing technique maintains the upper portions of the encapsulated RF-shielding wirebonds 51 at or close to the resulting upper surface of the overmold structure.

In the example molding configuration 52 of FIG. 2K, molding compound can be introduced from one or more sides of the molding volume 55 as indicated by arrows 56. In some implementations, such an introduction of molding compound can be performed under heated and vacuum condition to facilitate easier flow of the heated molding compound into the volume 55.

FIG. 2L shows an example configuration 58 where molding compound has been introduced into the volume 55 as described in reference to FIG. 2K and the molding cap removed to yield an overmold structure 59 that encapsulates the various parts (e.g., die, die-connecting wirebonds, and SMT devices). The RF-shielding wirebonds are also shown to be substantially encapsulated by the overmold structure 59. The upper portions of the RF-shielding wirebonds are shown to be at or close to the upper surface 60 of the overmold structure 59.

FIG. 2M shows an example panel 62 that has overmold structures 59 formed over the multiple cookie sections. Each cookie section's overmold structure can be formed as described herein in reference to FIGS. 2K and 2L. The resulting overmold structure 59 is shown to define a common upper surface 60 that covers the multiple modules of a given cookie section.

The molding process described herein in reference to FIGS. 2K-2M can yield a configuration where upper portions of the encapsulated RF-shielding wirebonds are at or close to the upper surface of the overmold structure. Such a configuration may or may not result in the RF-shielding wirebonds forming a reliable electrical connection with an upper conductor layer to be formed thereon.

In block 12m of FIG. 1, a top portion of the overmold structure can be removed to better expose upper portions of the RF-shielding wirebonds. FIG. 2N shows an example configuration 64 where such a removal has been performed. In the example, the upper portion of the overmold structure 59 is shown to be removed to yield a new upper surface 65 that is lower than the original upper surface 60 (from the molding process). Such a removal of material is shown to better expose the upper portions 66 of the RF-shielding wirebonds 51.

The foregoing removal of material from the upper portion of the overmold structure 59 can be achieved in a number of ways. FIG. 2O shows an example configuration 68 where such removal of material is achieved by sand-blasting. In the example, the left portion is where material has been removed to yield the new upper surface 65 and better exposed upper portions 66 of the RF-shielding wirebonds. The right portion is where material has not been removed, so that the original upper surface 60 still remains. The region indicated as 69 is where the material-removal is being performed.

In the example shown in FIG. 2O, a modular structure corresponding to the underlying module substrate 20 (depicted with a dotted box 22) is readily apparent from the exposed upper portions 66 of the RF-shielding wirebonds that are mostly encapsulated by the overmold structure 59. Such modules will be separated after a conductive layer is formed over the newly formed upper surface 65.

In block 12n of FIG. 1, the new exposed upper surface resulting from the removal of material can be cleaned. By way of an example, the substrates can be run through a solvent or aqueous cleaning step. Such a cleaning step can be achieved by, for example, a nozzle spray, or full immersion in liquid.

In block 12o of FIG. 1, an electrically conductive layer can be formed on the new exposed upper surface of the overmold structure, so that the conductive layer is in electrical contact with the upper portions of the RF-shielding wirebonds. Such a conductive layer can be formed by a number of different techniques, including methods such as spraying or printing.

FIG. 2P shows an example configuration 70 where an electrically conductive layer 71 has been formed over the upper surface 65 of the overmold structure 59. As described herein, the upper surface 65 better exposes the upper portions 66 of the RF-shielding wirebonds 51. Accordingly, the formed conductive layer 71 forms improved contacts with the upper portions 66 of the RF-shielding wirebonds 51.

As described in reference to FIG. 2J, the RF-shielding wirebonds 51 and the ground plane 30 can yield an interconnected RF-shielding structure at sides and underside of the area defined by the RF-shielding wirebonds 51. With the upper conductive layer 71 in electrical contact with the RF-shielding wirebonds 51, the upper side above the area is now shielded as well, thereby yielding a shielded volume.

FIG. 2Q shows an example panel 72 that has been sprayed with conductive paint to yield an electrically conductive layer 71 that covers multiple cookie sections. As described in reference to FIG. 2M, each cookie section includes multiple modules that will be separated.

In block 12p of FIG. 1, the modules in a cookie section having a common conductive layer (e.g., a conductive paint layer) can be singulated into individual packaged modules. Such singulation of modules can be achieved in a number of ways, including a sawing technique.

FIG. 2R shows an example configuration 74 where the modular section 20 described herein has been singulated into a separated module 75. The overmold portion is shown to include a side wall 77; and the module substrate portion is shown to include a side wall 76. Collectively, the side walls 77 and 76 are shown to define a side wall 78 of the separated module 75. The upper portion of the separated module 75 remains covered by the conductive layer 71. As described herein in reference to FIG. 2B, the lower surface 27 of the separated module 75 includes contact pads 28, 29 to facilitate electrical connections between the module 75 and a circuit board such as a phone board.

FIGS. 2S1, 2S2 and 2S3 show front (also referred to as top herein), back (also referred to as bottom herein) and perspective views of the singulated module 75. As described herein, such a module includes RF-shielding structures encapsulated within the overmold structure; and in some implementations, the overall dimensions of the module 75 is not necessarily any larger than a module without the RF-shielding functionality. Accordingly, modules having integrated RF-shielding functionality can advantageously yield a more compact assembled circuit board since external RF-shield structures are not needed. Further, the packaged modular form allows the modules to be handled easier during manipulation and assembly processes.

In block 12q of FIG. 1, the singulated modules can be tested for proper functionality. As discussed above, the modular form allows such testing to be performed easier. Further, the module's internal RF-shielding functionality allows such testing to be performed without external RF-shielding devices.

FIG. 2T shows that in some embodiments, one or more of modules included in a circuit board such as a wireless phone board can be configured with one or more packaging features as described herein. Non-limiting examples of modules that can benefit from such packaging features include, but are not limited to, a controller module, an application processor module, an audio module, a display interface module, a memory module, a digital baseband processor module, GPS module, an accelerometer module, a power management module, a transceiver module, a switching module, and a power amplifier module.

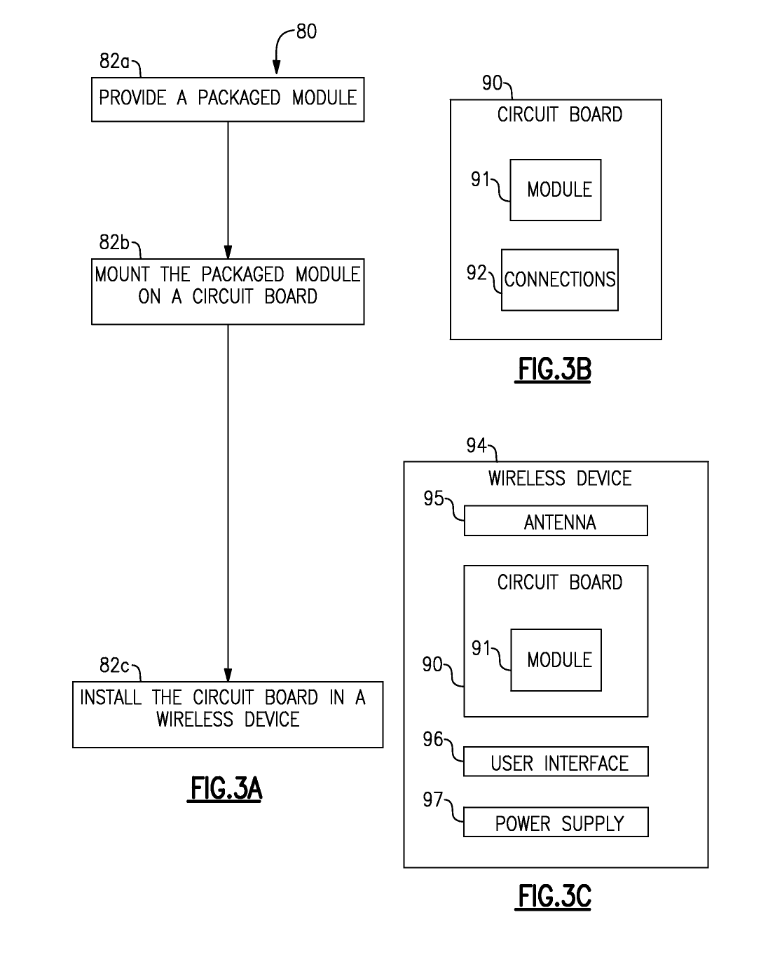

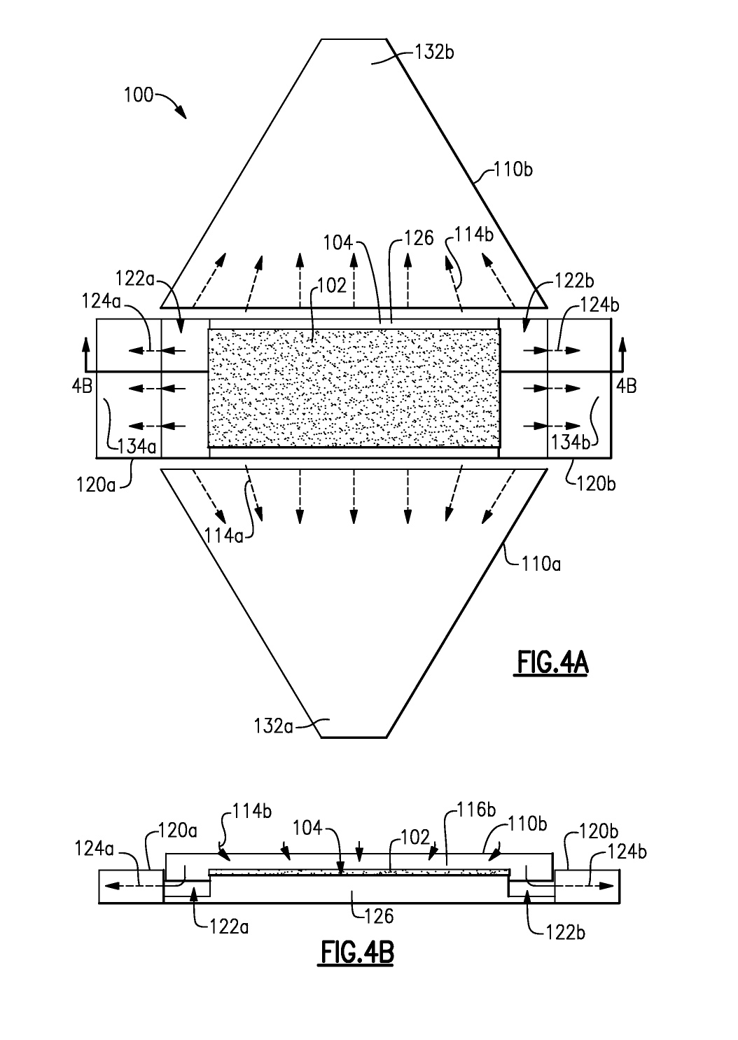

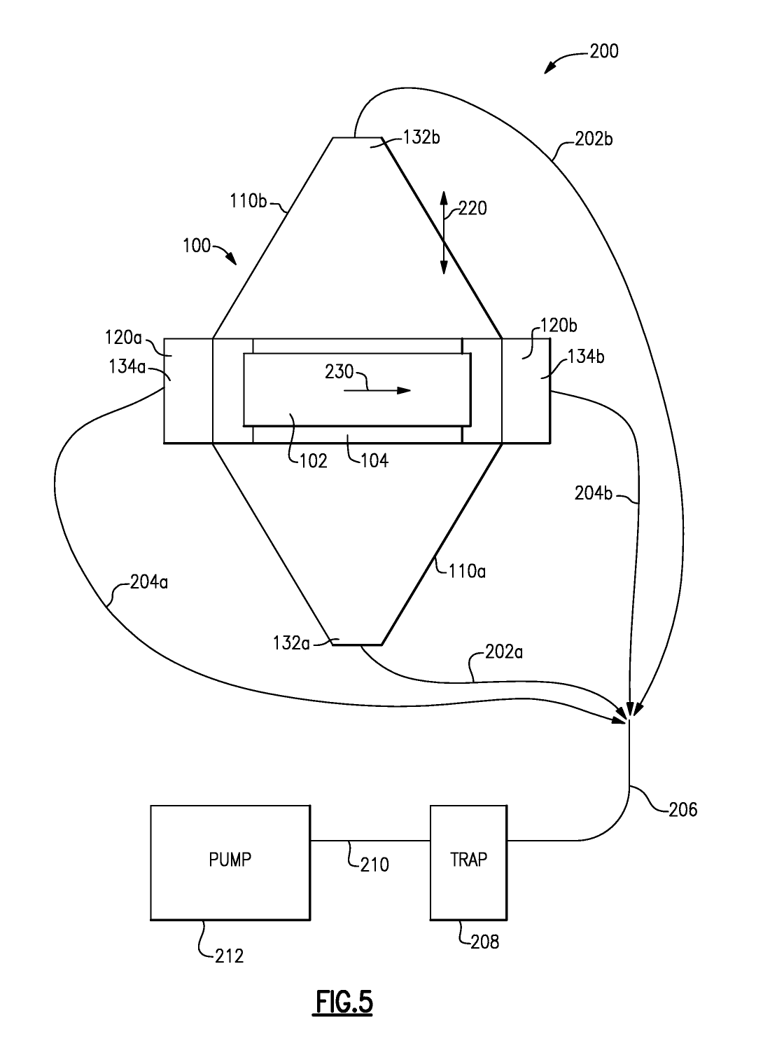

FIG. 3A shows a process 80 that can be implemented to assemble a packaged module having one or more features as described herein on a circuit board. In block 82a, a packaged module can be provided. In some embodiments, the packaged module can represent a module described in reference to FIG. 2T. In block 82b, the packaged module can be mounted on a circuit board (e.g., a phone board). FIG. 3B schematically depicts a resulting circuit board 90 having module 91 mounted thereon. The circuit board can also include other features such as a plurality of connections 92 to facilitate operations of various modules mounted thereon.

In block 82c, a circuit board having modules mounted thereon can be installed in a wireless device. FIG. 3C schematically depicts a wireless device 94 (e.g., a cellular phone) having a circuit board 90 (e.g., a phone board). The circuit board 90 is shown to include a module 91 having one or more features as described herein. The wireless device is shown to further include other components, such as an antenna 95, a user interface 96, and a power supply 97.

As described in reference to FIGS. 2P and 2Q, the electrically conductive layer 71 can be formed by, for example, spraying of conductive paint. Such spraying of conductive paint can be performed on a given panel having multiple modular devices yet to be singulated.

With spray-application of paint, there is typically a mist of material that can coat exposed areas outside of the area being painted. For example, areas surrounding the perimeter of a panel being painted can be coated with mist when paint is sprayed on the panel. In some production situations (e.g., in high-throughput mass production situations) without a mist-collection system having one or more features as described herein, such an overspray mist can build up significantly and yield undesirable effects such as dripping down onto a panel-transport system and contaminating the bottom side of the panel. Such contamination can result in, for example, shorting of I/O and/or grounding pads (e.g., 28, 29 in FIG. 2S2) after processing of, for example, 10 to 20 panels. Such a build-up of mist can also require frequent cleaning (e.g., every 10 to 20 minutes) of the transport system to prevent the panel-bottoms from becoming contaminated.

In the context of high-throughput mass production settings, negative effects in production volume and yield resulting from the foregoing disruptions and stoppages are readily apparent. If a painting system is in series with other processing systems (upstream and/or downstream), such processing systems will likely need to be suspended during cleaning and/or maintenance of the painting system, thereby significantly interrupting the production volume. Even if a number of such painting systems are provided in parallel, the overall maintenance/cleaning frequency simply increases, typically requiring increased time and resource of operators.

The foregoing examples of negative effects that can result from painting systems without a mist-collection having one or more features as described herein are generally in the context of directly impacting the panels themselves. Other negative effects can also result from painting systems that do not have such a mist-collection system. For example, paint accumulated on different parts of a paint spraying chamber can lead to general unclean conditions due to, for example, the paint itself, as well as contaminants sticking to such accumulated paint. Such an unclean condition can negatively impact the reliability of the various parts of the paint spraying chamber, which in turn can negatively impact the quality and volume of the panels being processed. Further, such an unclean condition of the paint spraying condition may require extended downtime of the painting system for maintenance and/or cleaning.

In addition to the foregoing general cleanliness problems caused by the accumulation of paint, there can also be problems arising from electrically conductive nature of paint being applied in some painting systems. Mist from such conductive paint can coat electrical and/or mechanical equipment associated with a paint spraying system. Such a coating of conductive paint can undesirably alter the electrical and/or mechanical properties of such equipment, which in turn can negatively impact the quality and volume of the panels being processed. Again, such a condition of the electrical and/or mechanical equipment may require extended downtime of the painting system for maintenance and/or cleaning. In some situations, such accumulation of conductive paint may render such equipment un-usable and un-repairable.

Described herein are various examples of a mist-collection system that can be configured to enable continuous or extended spraying of panels without the need to stop and clean the internal parts (e.g., during high-volume manufacturing situations). In some implementations, such a system can capture a majority of mists (including those resulting from overspray) generated during the panel-spraying process.

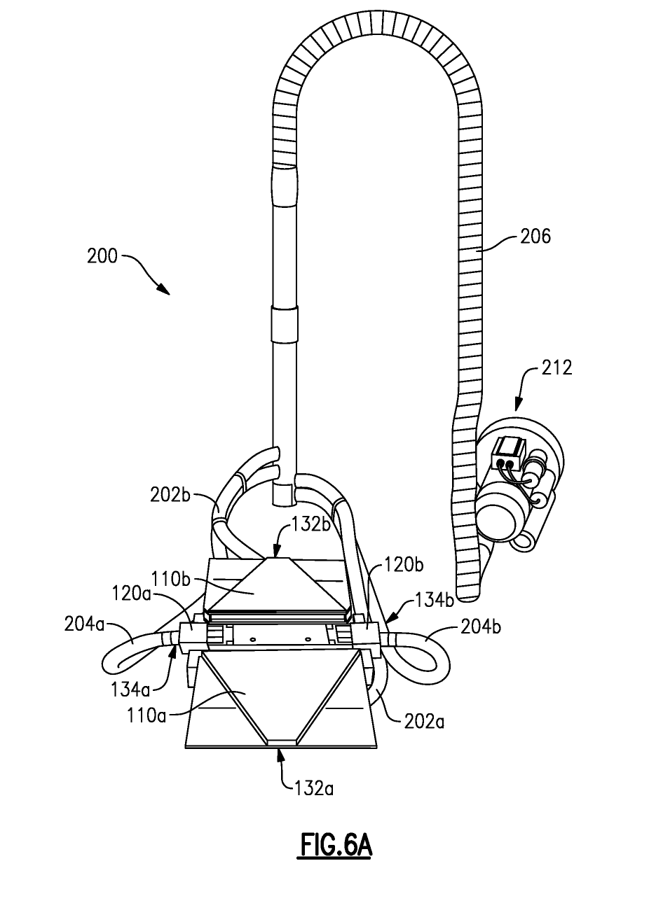

FIGS. 4A and 4B show a plan view and a side view of a painting platen 100 configured to support a panel 102 during a spray-painting process. The platen 100 is shown to include a plurality of mist-collection structures 110a, 110b, 120a, 120b. Each of the mist-collection structures can be configured as a passageway having an input opening that generally faces a corresponding side of the panel 102 being sprayed, and an output configured to allow coupling with a suction device. For example, the mist-collection structure 110a (also referred to herein as a front platen) can be a flat horn-shaped structure having its wide end input opening facing one of the two longer sides of panel 102 so as to allow receiving of mists (depicted as arrows 114a) when suction is applied through its narrow end 132a. Similarly, the mist-collection structure 110b (also referred to herein as a back platen) can be a flat horn-shaped structure having its wide end input opening facing the other longer side of the panel 102 so as to allow receiving of mists (depicted as arrows 114b) when suction is applied through its narrow end 132b. The horn-shaped structures 110a, 110b may or may not be symmetric.

Mists generated at or near the ends of the panel 102 are shown to be collected by the mist-collection structures 120a, 120b. The mist-collection feature 120a (also referred to herein as a side platen or a left platen) is shown to be a flat box-shaped structure having an input opening facing one of the two shorter sides of the panel 102 so as to allow receiving of mists (depicted as arrows 124a) when suction is applied through its output end 134a. Similarly, the mist-collection feature 120b (also referred to herein as a side platen or a right platen) is shown to be a flat box-shaped structure having an input opening facing the other shorter side of the panel 102 so as to allow receiving of mists (depicted as arrows 124b) when suction is applied through its output end 134b. The left and right platens 110a, 110b may or may not be symmetric.

As described herein, the horn-shaped platens 110a, 110b can allow coverage of a relatively large dimension (e.g., the length dimension of the panel 102) while utilizing smaller-dimensioned suction conduits. The side platens 120a, 120b are shown to provide smaller-dimensioned coverage. Accordingly, such platens can have simpler shapes. While described in the context of example shapes such as horn and box shapes, it will be understood that other shapes can also be utilized.

In the side view of FIG. 4B, one can see that in some embodiments, the panel 102 can be supported by a platform 104 during the painting process. The platform 104 can be dimensioned so that the panel 102 is at a height that is higher than the lower edge of the wide-end input opening (116b) of the horn-shaped platen (shown as 110b), but lower than the upper edge of the same opening. Such a configuration can yield a vertical dimension of the input opening 116 of the horn-shaped platen 110 which covers space above and below the long edge of the panel 102. Similarly, the input opening 116 of the horn-shaped platen 110 can have a horizontal dimension that is greater than the length of the panel 102, to thereby provide mist collection coverage at or beyond the end portions of the panel 102. It will be understood that parameters such as the foregoing opening dimension and relative positions (height and lateral) of the panel 102 and the horn-shaped platen 110 can be selected to accommodate various spray painting configurations.

Also shown in the side view of FIG. 4B, the height of the panel 102 can be at a height that is higher than the lower edges of the input openings of the side platens (120). The height of the panel 102 may or may not be lower than the upper edges of the same opening. In some embodiments, such a configuration can facilitate feeding and removal of panels from the painting location on the platform 104. An example of such feeding and removal of panels is described herein in greater detail. The input opening of each of the side platens (120) can have a horizontal dimension that is greater than the width of the panel 102, to thereby provide mist collection coverage at or beyond the end portions of the panel 102. It will be understood that parameters such as the foregoing opening dimension and relative positions (height and lateral) of the panel 102 and the side platens 120 can be selected to accommodate various spray painting configurations.

In some embodiments, the platform 104 can be configured to allow securing of the panel 102 during the spraying process. For example, the platform 104 can include suction apertures that can be activated to hold the panel 102.

In some embodiments, the platen 100 can be configured to allow automated feeding and removal of panels. Suppose that such feeding occurs from left to right in FIGS. 4A and 4B. To accommodate such a feature, some or all portions of the platform 104 can be configured to be movable vertically to facilitate such left-to-right movements of the panels. For example, and as shown in FIG. 4B, the platform 104 can include a portion 126 supporting the panel 102. The supporting portion 126 can have its height changed to allow the panel 102 to be positioned for a desired mist flow (e.g., into the platens 110 and 120) when being painted, and to allow the panel 102 to be moved horizontally from left to right for positioning to and away from the supporting portion 126.

In the example shown in FIGS. 4A and 4B, the side platens 120a, 120b can be fixed vertically to accommodate the foregoing motion of the panel 102. To accommodate flow of mist into the side platens 120a, 120b positioned at such a height, the platform 104 can be dimensioned to define respective spaces 122a, 122b.

FIG. 5 schematically depicts an example mist-collection system 200 that includes the platen 100 described in reference to FIGS. 4A and 4B. The system 200 is shown to include conduits 202a, 202b, 204a, 204b that couple the output ends 132a, 132b, 134a, 134b, respectively, to a common conduit 206. Such conduits can be configured to provide desired levels of suction at the input openings of the horn-shaped and box-shaped platens 110, 120 by, for example, being coupled to a pump 212. Examples of such conduits are described herein in greater detail.

FIG. 5 shows that in some embodiments, paint particles in the mist suctioned away from the platen 100 can be trapped by a trap 208 as the mist is passed from the common conduit 206 to the pump 212. Thus, the gas (e.g., air) between the trap 208 and the pump 212 can have reduced paint content or be substantially free of paint.

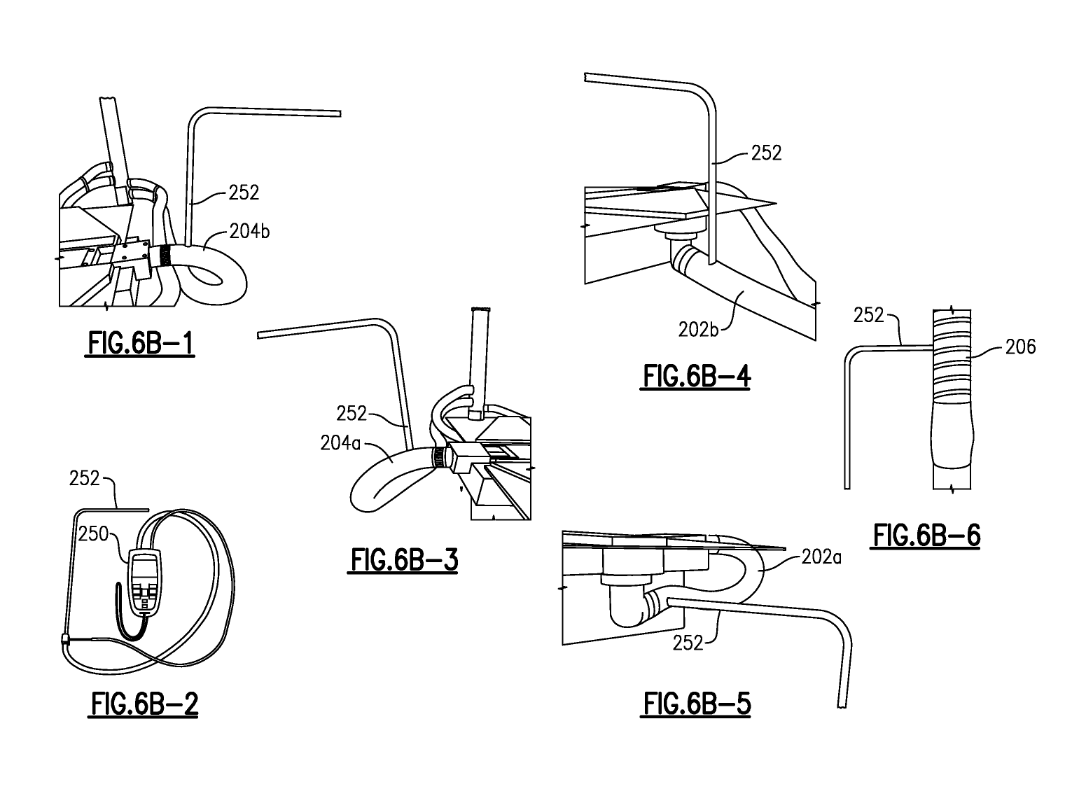

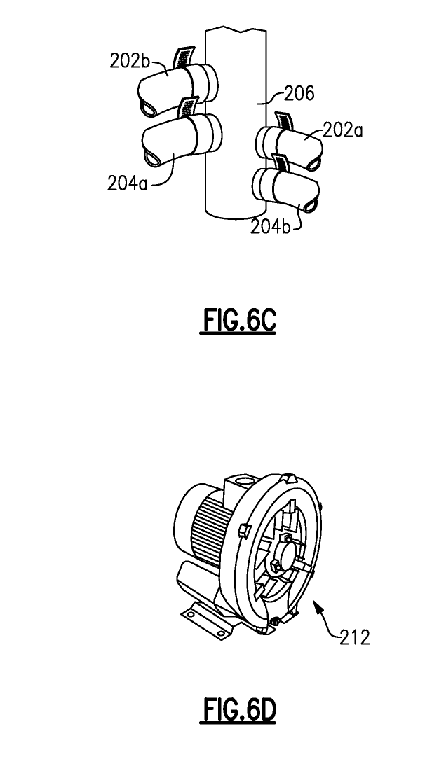

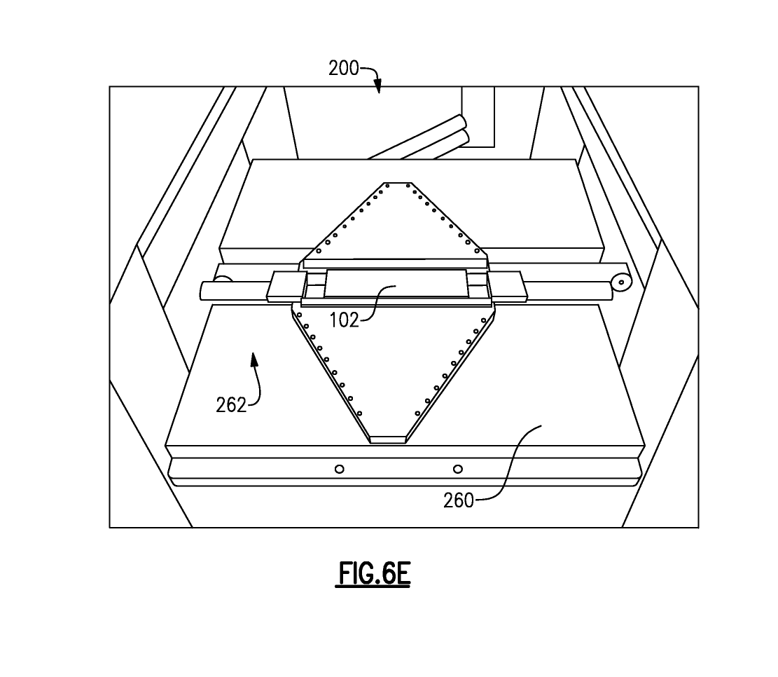

FIGS. 6A-6D show various example components that can be utilized for the mist-collection system 200 of FIG. 5. FIGS. 6A-6C show some of such components in a prototype configuration, and FIG. 6D shows some of such components in a high-throughput manufacturing configuration.

FIG. 6A shows that in some embodiments, the pump 212 of FIG. 5 can include a regenerative blower. In the example shown, the regenerative blower is a commercially available Atlantic Blowers regenerative blower (model AB-401E, 3-horsepower). The regenerative blower 212 is shown to provide suction through a 2-inch ducting 206 (e.g., the common conduit 206 in FIG. 5) which is in turn connected to a reducing-manifold. The four ductings 202a, 202b, 204a, 204b connecting the output ends 132a, 132b, 134a, 134b of the front/back platens 110a, 110b and side platens 120a, 120b are shown to be 1-inch ductings. Thus, the example reducing-manifold is a 2-inch-to-1-inch reduction-manifold.

The four 1-inch ductings 202a, 202b, 204a, 204b are shown to have the example lengths as shown, and are substantially free of sharp bends such as 90-degree bend. Such sharp bend can promote accumulation of paint particles; thus, reduction or elimination of such bends can reduce likelihood of undesired accumulations.

In the example shown, the 1-inch ductings 202a, 202b for the front and back platens are shown to be coupled to the undersides of the outputs of the horn-shaped platens 110a, 110b. The 1-inch ductings 204a, 204b for the side platens 120a, 120b are shown to be coupled to the side-ends of their outputs.

In some embodiments, the amount of suction at an input opening of a given platen can be controlled by, for example, the ducting size, flow rate, or some combination thereof. If the ducting size is fixed in a given configuration, flow rate can be adjusted by, for example, the operation of the regenerative blower. In such a situation, setting and/or monitoring of flow rates in the ductings can be desirable.

FIG. 6B shows examples of how flow rate can be measured at various parts of the ductings. An electronic flow meter 250 (e.g., Fluke 922) with a pitot probe 252 (FIG. 6B-2) can be utilized to measure air flow along the individual ductings 202a, 202b, 204a, 204b (FIGS. 6B-5, 6B-4, 6B-3, 6B-1, respectively). Air flow can also be measured along the common ducting 206 (FIG. 6B-6). Preferably, the common ducting 206 is capable of sustaining a flow that is sufficient to accommodate the desired flows of the individual ductings 202a, 202b, 204a, 204b.

In the examples shown in FIG. 6C, the pitot tube 252 is depicted as being temporarily installed in the ductings to facilitate obtaining of desired air flows. Once the pitot tube 252 is removed, the tube-insertion hole can be sealed to inhibit leakage. In some embodiments, pitot tubes can remain installed in selected ductings to monitor air flow rates during operation.

FIG. 6C shows a more detailed view of how the example 1-inch ductings 202a, 202b, 204a, 204b can be coupled to the example 2-inch common ducting 206. As described herein, such a common ducting 206 can be coupled to the regenerative blower 212 which is shown in an isolated view in FIG. 6D.

Table 1 lists flow readings resulting from the example AB-401B regenerative blower and the foregoing ducting configuration; and Table 2 lists flow readings associated with the same ducting configuration, but with an example non-regenerative blower (a LM-4B volume blower, not shown). One can see that flow rates at the 1-inch ductings due to the regenerative blower are about three times greater than those due to the non-regenerative blower.

TABLE 1

| Ducting | Flow rate (cubic feet per minute) |
|---|---|
| 2-inch common ducting | 341 |
| 1-inch ducting 202a | 66 |
| 1-inch ducting 202b | 75 |
| 1-inch ducting 204a | 86 |
| 1-inch ducting 204b | 72 |

TABLE 2

| Ducting | Flow rate (cubic feet per minute) |
|---|---|
| 5-inch common ducting | 775 |
| 1-inch ducting 202a | 25 |
| 1-inch ducting 202b | 26 |
| ¾-inch ducting 204a | 21 |
| ¾-inch ducting 204b | 22 |

From the example measurements of Table 2, one can see that use of an 1-inch ducting generally yields a higher flow rate than that of a ¾-inch ducting, as expected. It is also noted that the 5-inch common ducting is unnecessarily too large, with its flow rate capability highly mis-matched with the four smaller 1-inch or ¾-inch ductings.

From the example measurements of Table 1, one can see that use of the example regenerative blower and/or the general matching of the 2-inch common ducting with the four 1-inch ductings yield a relatively high flow rate within the 1-inch ductings, and thus at their respective platen inputs. In some embodiments, the mist-collection system as described herein can be configured so that each of the conduits coupled to the shaped platens (e.g., horn-shaped and box-shaped) has a flow rate that is at least 50 CFM (cubic feet per minute), at least 60 CFM, 70 CFM, or 80 CFM. Such relatively high flow rate can facilitate effective pulling of paint mist during the spraying process.

FIG. 6E shows an example spray-painting chamber 262 configured for high-volume manufacturing setting. Such a chamber can be combined with a mist-collection system 200 as described herein to facilitate spray-painting of panels in a high-volume setting. In FIG. 6E, a panel 102 to be spray-painted is shown to be positioned between the platen openings. Various ductings and pump as described herein are generally hidden from view, but can be similar to those described herein.

In FIG. 6E, a supporting surface 260 can provide support for the platens, as well as mechanisms for moving various parts associated with the mist collection system 200. For example, an actuation mechanism (including a motor near the output end of the back horn-shaped platen) can be provided to allow lateral movement (arrow 220 in FIG. 5) of the back horn-shaped platen away from or towards the front horn-shaped platen. Such motions can allow the mist-collection system to accommodate different sized panels.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A device for spray-painting a panel having electronic modules formed thereon, the device comprising:
a platform configured to support the panel during a paint-spraying process; and
a mist-collector positioned relative to the platform, the mist-collector including an input in communication with an output, the mist-collector configured to be capable of providing suction at a region along one or more sides of the platform to thereby capture at least some of a paint mist generated during the paint-spraying process through the input.

2. The device of claim 1 wherein the platform has a rectangular shape, and the mist collector includes a shaped conduit adjacent each of the four sides of the platform.

3. The device of claim 2 wherein the shaped conduit adjacent the longer side of the platform has a horn shape with a wider end defining the input and a narrower end defining the output.

4. The device of claim 3 wherein the output includes an opening defined on a bottom surface of the horn shape.

5. The device of claim 3 wherein the wider end of the input defines a rectangle, the panel being positioned at a height that is between the upper and lower sides of the rectangular input.

6. The device of claim 5 wherein the rectangular input has a length that is greater than the length of the panel such that the panel is between the lateral ends of the rectangular input.

7. The device of claim 2 wherein the shaped conduit adjacent the shorter side of the platform has a box shape with one end defining the input and the opposite end defining the output.

8. The device of claim 7 wherein the output includes an opening defined on a side surface of the opposite end.

9. The device of claim 7 wherein the input end defines a rectangle, the panel being positioned at a height that is higher than the lower side of the rectangular input.

10. The device of claim 1 wherein the platform is configured to secure the panel during the paint-spraying process.

11. The device of claim 10 wherein the platform includes a plurality of suction apertures configured to provide suction for holding the panel.

12. A mist-collection system for spray-painting a panel having electronic modules formed thereon, the mist-collection system comprising:
a platform configured to support the panel during a paint-spraying process;
a mist-collector positioned relative to the platform, the mist-collector including an input in communication with an output, the mist-collector configured to provide suction at a region along one or more sides of the platform to thereby capture at least some of a paint mist generated during the paint-spraying process through the input; and
a pump in communication with the mist-collector to provide the suction.

13. The mist-collection system of claim 12 further comprising a ducting assembly configured to connect the output of the mist-collector to the pump.

14. The mist-collection system of claim 13 wherein the platform has a rectangular shape, and the mist collector includes a shaped conduit adjacent each of the four sides of the platform.

15. The mist-collection system of claim 14 wherein the ducting assembly includes a tubing having a first inner diameter for each of the four shaped conduits.

16. The mist-collection system of claim 15 wherein ducting assembly further includes a common ducting having a second inner diameter that is larger than the first diameter, the common ducting configured to couple the four tubings with the pump.

17. The mist-collection system of claim 16 wherein the common ducting includes a reducing manifold having inputs dimensioned to couple to the four tubings and an output having the second diameter.

18. The mist-collection system of claim 14 wherein the mist-collection system is configured to provide at least 50 cubic feet per minute through each of the four shaped conduits.

19. The mist-collection system of claim 12 wherein the pump includes a regenerative blower.

20. A method for spray-painting a panel having electronic modules formed thereon, the method comprising:
positioning the panel on a platform;
spraying an electrically conductive paint on an upper surface of the panel; and
providing suction to a region along one or more sides of the platform to thereby capture at least some of a paint mist generated during the spraying.
